(19) United States
(12) Patent Application Publication
(10) Pub. No.: US 2012/0251196 A1
(43) Pub. Date: Oct. 4, 2012

(54) IMAGE FORMING APPARATUS

(76) Inventors: Masayuki YAMADA, Osaka (JP); Yoshitaka TOKORO, Osaka (JP)

(21) Appl. No.: 13/432,189

(22) Filed: Mar. 28, 2012

(30) Foreign Application Priority Data
Mar. 31, 2011 (JP) P2011-077154

(51) Int. Cl. G03G 15/20

(52) U.S. Cl. 399/308

(57) ABSTRACT

There are provided shielding components that are located between supporting portions which pivotally support transfer rollers which are located facing photosensitive drums and a rear surface of an intermediate transfer belt, and that are also located also on both sides of a direction which orthogonally intersects the direction of movement of the intermediate transfer belt, and that are also fixed to the supporting portions.

### CROSS REFERENCE TO RELATED APPLICATIONS

Priority is claimed on Japanese Patent Application No. 2011-077154, filed Mar. 31, 2011, the contents of which are incorporated herein by reference.

### BACKGROUND OF THE DISCLOSURE

1. Field of the Disclosure

The present disclosure relates to an image forming apparatus.

2. Description of Related Art

Conventionally, a plurality of photosensitive drums that correspond to each of the colors of yellow (Y), magenta (M), cyan, (C), and black (BK) are placed in a developing unit that forms part of an image forming apparatus such as a full-color printer or copy machine. An electrostatic latent image is formed on the circumferential surface of each photosensitive drum using a laser scanning unit, and toner images in the colors that are supplied by the supplied toner of each color are respectively formed.

The toner images of each color that are formed on the circumferential surface of each photosensitive drum are sequentially transferred via superimposition onto an intermediate transfer belt that is formed, for example, by an endless belt which is driven to rotate. As a result, a color image is synthesized on the intermediate transfer belt. Next, the color image that has been synthesized on the intermediate transfer belt is transferred onto a recording medium such as copy paper. It then undergoes fixing processing by being compressed and heated by a fixing apparatus.

In a full-color type of image forming apparatus, even if the selected printing mode is a monochromatic mode employing only black printing, the transfer rollers used for color printing still press the intermediate transfer belt onto the photosensitive drum. As a consequence, unnecessary tensile force is generated in the intermediate transfer belt, and problems such as the longevity of the intermediate transfer belt being shortened arise.

In order to solve problems such as this, image forming apparatuses have been developed that are provided with what is known as a ‘3-color removing mechanism’ which is a mechanism that, when monochrome mode is selected, removes the pressing force on the color transfer rollers which correspond to yellow, magenta, and cyan.

In this 3-color removing mechanism, a structure is employed in which the three transfer rollers that correspond to yellow, magenta, and cyan are installed inside a housing for these colors, and when monochrome mode is selected (i.e., when 3-color removal is in effect), this color housing is moved in a direction away from the three photosensitive drums that are provided facing the three transfer rollers.

However, in an image forming apparatus that is provided with a conventional 3-color removing mechanism, if the selected printing mode is the monochrome mode for black printing, and the color housing in which the transfer rollers for printing colors have been installed is moved in a direction away from the photosensitive drums that are provided facing the transfer rollers, then the gap between the color housing and the intermediate transfer belt is widened, and any toner that is spattered inside the apparatus might easily fall on the inner surface side of the intermediate transfer belt.

In addition, if toner does fall on the inner surface side of the intermediate transfer belt, then the problem arises that not only does the toner become adhered to the inner surface of the intermediate transfer belt, but this adhered toner sticks to the roller of the cleaning device and obstructs the smoothness of the roller surface. This has led to defects in the cleaning of the outer surface side of the intermediate transfer belt, and has caused a decrease in product quality.

### SUMMARY

The present disclosure was conceived in view of the above described problems and it is an object thereof to provide an image forming apparatus in which toner can be prevented from falling onto the inner surface side of the intermediate transfer belt.

The present disclosure employs the following structure for sake of solving the above-described problems.

According to a first embodiment of the present invention, an image forming apparatus includes: an intermediate transfer belt onto which toner images are transferred from a plurality of photosensitive drums; transfer rollers that are located facing the photosensitive drums and nipping the intermediate transfer belt between the transfer rollers and the photosensitive drums; and supporting portions that pivotally support the transfer rollers. The image forming apparatus is also provided with shielding components that are located between the supporting portions and the intermediate transfer belt, and that are located on both sides of a direction that orthogonally intersects the direction of movement of the intermediate transfer belt, and that are also fixed to the supporting portions.

### BRIEF DESCRIPTION OF THE DRAWINGS

FIG. 1 is a schematic structural view of a printer in which an image forming apparatus of an embodiment of the present invention has been employed;

FIG. 2A is a detailed view of the image forming section of a printer in which the image forming apparatus of an embodiment of the present disclosure has been utilized, and shows the position of a color housing during color printing;

FIG. 2B shows the position of the color housing during monochrome printing according to the image forming apparatus of an embodiment of the present disclosure;

FIG. 3 is a side view of the image forming section of a printer in which the image forming apparatus of an embodiment of the present disclosure has been utilized;

FIG. 4 is a plan view of the image forming section of a printer in which the image forming apparatus of an embodiment of the present disclosure has been utilized; and

FIG. 5 is a plan view excluding the intermediate transfer belt of the image forming section of the printer in which the image forming apparatus of an embodiment of the present disclosure has been utilized.

### DETAILED DESCRIPTION OF THE DISCLOSURE

Hereinafter, embodiments of an image forming apparatus of the present disclosure will be described with reference to the drawings. Note that in the attached drawings, the scale of each component has been suitably altered in order to show each component at a recognizable size. Furthermore, in the following description, a full-color type of printer P is described as an example of the image forming apparatus of the present disclosure.

### First Embodiment

### (Schematic Structure of an Image Forming Apparatus)

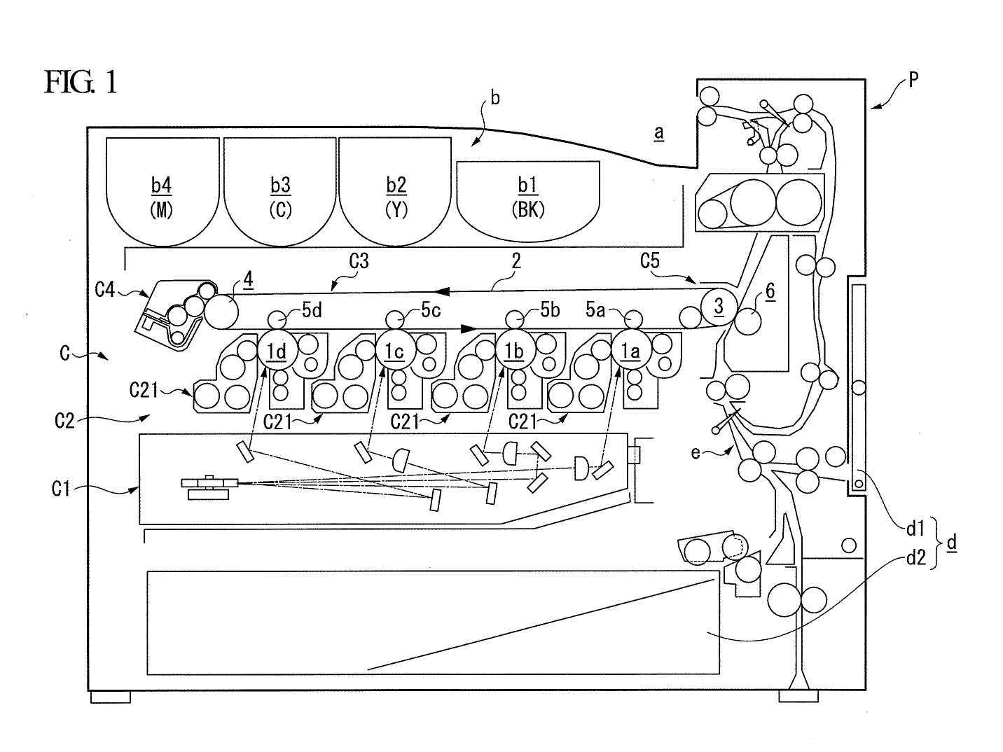

FIG. 1 is a schematic structural view of the printer P. A paper discharge section a, a toner cartridge housing section b, an image forming section c, and a recording sheet section d are provided in the printer P in the above sequence moving from the top portion to the bottom portion of the printer P. In addition, a sheet transporting section e is also provided in the printer P extending from the recording sheet section d which is located in the bottom portion thereof to the sheet discharge section which is located in the top portion thereof.

The sheet discharge section is constructed such that recording sheet (i.e., a recording medium such as paper) on which predetermined contents have been printed is discharged via the sheet transporting section e. An inclined portion is formed on a bottom surface of the sheet discharge section a, and when a plurality of sheets of recording sheet are being discharged, they can be stacked on top of each other with the edges on one end side thereof being aligned with each other.

The toner cartridge housing section b is constructed such that it is able to house a toner cartridge b1 for black toner (BK), a toner cartridge b2 for yellow toner (Y), a toner cartridge b3 for cyan toner (C), and a toner cartridge b4 for magenta toner (M). In addition, toner is able to be supplied from each of the cartridges b1, b2, b3 and b4 to a developing unit c2 of the image forming section c (described below).

The image forming section c is provided with a laser scanning unit c1, a developing unit c2, an intermediate transfer belt unit c3, a cleaning unit c4, a secondary transfer unit c5, and a fixing unit c6.

The laser scanning unit c1 is provided, in the same way as commonly known laser scanning units, with a light beam emitter that emits laser light, a polygon mirror that scans the light beams irradiated onto it from the light beam emitter, and an fθ lens that focuses the light beams scanned by the polygon mirror onto photosensitive drums 1a to 1d (described below).

The developing unit c2 develops electrostatic latent images that have been formed on the circumferential surfaces of the photosensitive drums 1a-1d as a result of toner being supplied to the photosensitive drums 1a-1d, and is provided with four developers c21 that correspond to the respective colors (BK, Y, C, M).

The photosensitive drums 1a-1d are provided at predetermined distances from each other in the transporting direction of the intermediate transfer belt unit c3. These photosensitive drums 1a-1d are provided so as to correspond to the respective colors (BK, Y, C, M). In addition, a charging unit, a charge eliminator, a cleaner, and the like are provided in each of the photosensitive drums 1a-1d, so that electrostatic latent images are created on the charged circumferential surfaces of the drums using the laser scanning unit c1, and toner images are then formed thereon by toner that is supplied from the toner cartridge housing section b to the developing unit c2.

The intermediate transfer belt unit c3 has an endless intermediate transfer belt (i.e., a primary transfer belt) 2 in the form of a laminated belt which is created by laminating an elastic layer onto a belt base body which is formed from a synthetic resin. The intermediate transfer belt 2 is provided in a substantially horizontal state such that one end side thereof (i.e., the right end side in FIG. 1) faces a portion of the transporting section e which is provided extending in a vertical direction at one end side of the main body of the printer P, and such that the other end side thereof (i.e., the left end side in FIG. 1) is located at the other end side of the main body of the printer P. Namely, the intermediate transfer belt 2 is constructed such that one end side thereof is stretched around a drive roller 3 that is connected to a drive source (not shown), and such that the other end side thereof is stretched around a tension roller 4. Note that this intermediate transfer belt unit c3 is described in further detail below using the drawings.

Primary transfer rollers 5a-5d are provided respectively at the positions where the photosensitive drums 1a-1d face the intermediate transfer belt 2 so as to nip the intermediate transfer belt 2 between themselves and the photosensitive drums 1a-1d. The primary transfer rollers 5a-5d are urged in a predetermined direction by an impelling device such as a coil spring or the like that is provided in each roller so as to be pressed against the photosensitive drums 1a-1d. In addition, the primary transfer rollers 5a-5d are constructed such that they are able to rotate in conjunction with the movement of the intermediate transfer belt 2. Note that, in addition to the drive roller 3 and the tension roller 4, the intermediate transfer belt 2 is also supported by a conversion roller that changes the direction of movement of the belt and by an idling roller.

The cleaning unit c4 is provided on the tension roller 4 side, and is constructed such that it is able to remove any toner remaining on the intermediate transfer belt 2 by means of a blade or the like, and then discharge the removed toner to a waste toner bottle (not shown).

The secondary transfer unit c5 is formed by the aforementioned drive roller 3 and by a secondary transfer roller 6 that is located opposite the drive roller 3 such that these rollers nip the intermediate transfer belt 2 between them.

As is described above, the secondary transfer roller 6 is positioned opposite the drive roller 3 with the intermediate transfer belt 2 nipped between these two rollers. Moreover, this secondary transfer roller 6 is provided in such a way that it is constantly pressed against the drive roller 3. Accordingly, when the intermediate transfer belt 2 is moved (i.e., rotated) by the drive roller 3, the secondary transfer roller 6 is able to rotate in conjunction with this movement.

Moreover, when recording sheet is delivered via the transporting section e, this recording sheet is interposed between the intermediate transfer belt 2 and the secondary transfer roller 6. In this state, the secondary transfer roller 6 can be rotated, and the recording sheet can be transported towards the fixing unit c6 side.

The fixing unit c6 is provided in a portion of the transporting section e on the downstream side of the portion where the secondary transfer unit c5 is provided, and is formed by a pair of rollers that are positioned such that they are able to nip the recording sheet being transported along this transporting section e. The fixing unit c6 is also constructed such that it is able to fix onto the recording sheet the toner image which has been pressed and heated by the pair of rollers and transferred onto the recording sheet by the secondary transfer unit c5.

The recording sheet section d is provided with a recording sheet supply tray d1 which is provided such that it is able to open and close freely relative to the apparatus main body, and a sheet cassette which is provided such that it is able to be freely withdrawn from the apparatus main body. The recording sheet section d is also constructed such that it is able to supply recording sheet one sheet at a time from the sheet supply tray d1 to the sheet transporting section e. It is also constructed such that it is able to supply recording sheet one sheet at a time from the sheet cassette d2 to the sheet transporting section e.

The sheet transporting section e is provided extending from the recording sheet section d which is positioned in a bottom portion of the printer P to the sheet discharge section which is provided in a top portion thereof, and is formed by a plurality of transporting rollers and guide plates. This sheet transporting section e is also constructed such that it is able to transport the recording sheet which was supplied from the recording sheet section d one sheet at a time to the sheet discharge section a.

In the printer P having the above described structure, when the driving of the drive roller 3 is started and the rotating of the intermediate transfer belt 2 has commenced, in the case of a color print, laser light that corresponds to the image data is irradiated from the laser scanning unit c1 onto the respective photosensitive drums 1a to 1d so as to form electrostatic latent images thereon. Toner images are then formed in the respective colors using supplied toner. These toner images in the respective colors are then sequentially transferred onto the intermediate transfer belt 2 by being superimposed thereon, with the result being that a color image is synthesized. Next, the color image synthesized on the intermediate transfer belt 2 is then transferred onto copy paper by the secondary transfer unit c5, and then undergoes fixing processing by being pressed and heated by the fixing unit c6. Lastly, the copy paper on which the color image has been printed is discharged to the sheet discharge portion c.

Note that in the case of a monochrome print, bias is only applied to the primary transfer roller 5a of the photosensitive drum 1a, and because bias is not applied to the other primary transfer rollers 5b to 5d, they are cancelled. Namely, the printing is done with 3-color removal in effect.

### (Structure of the Intermediate Transfer Belt Unit)

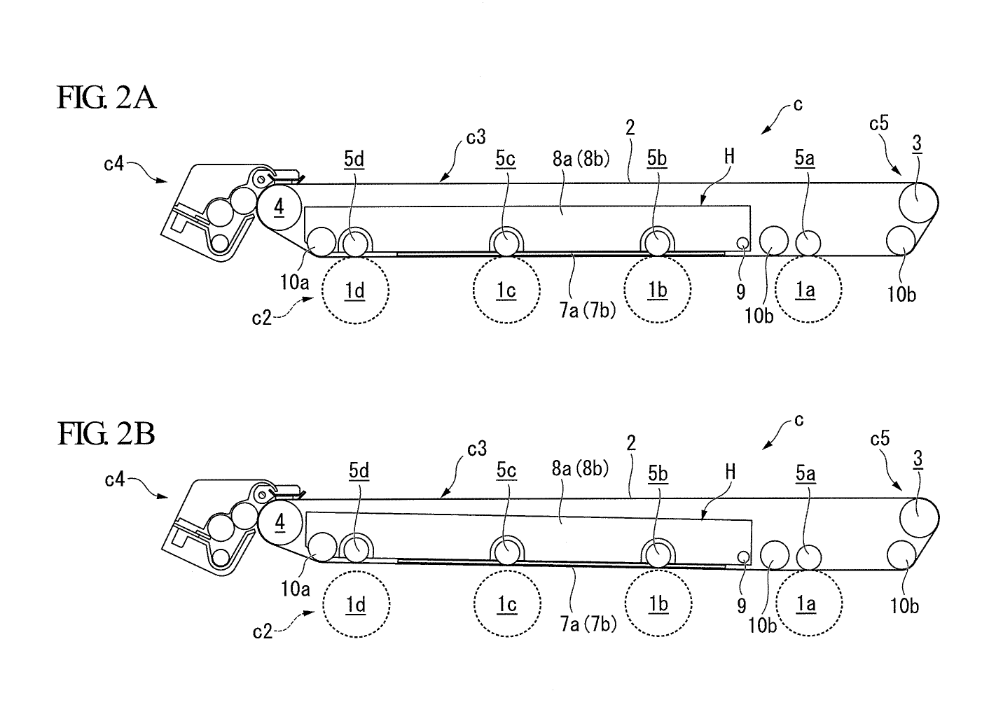

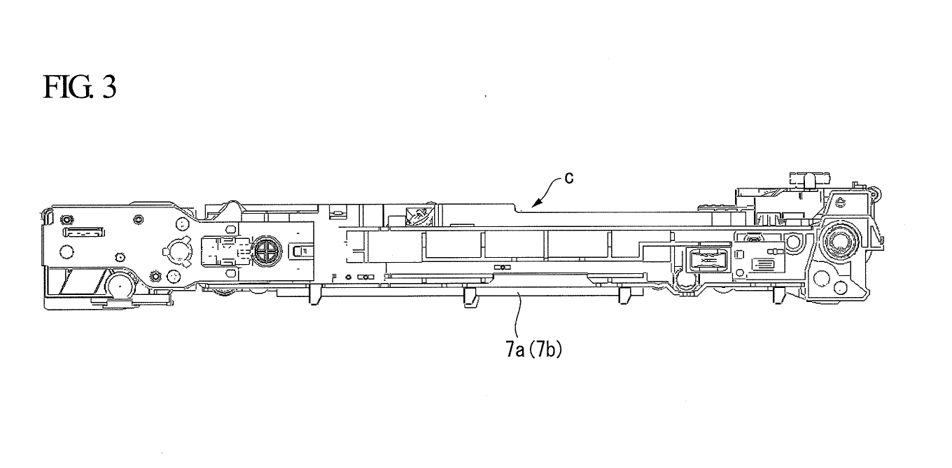

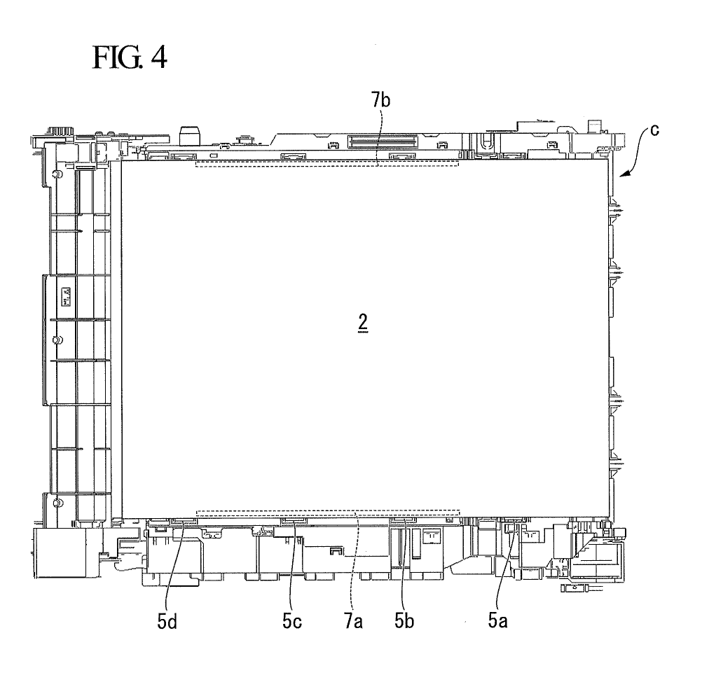

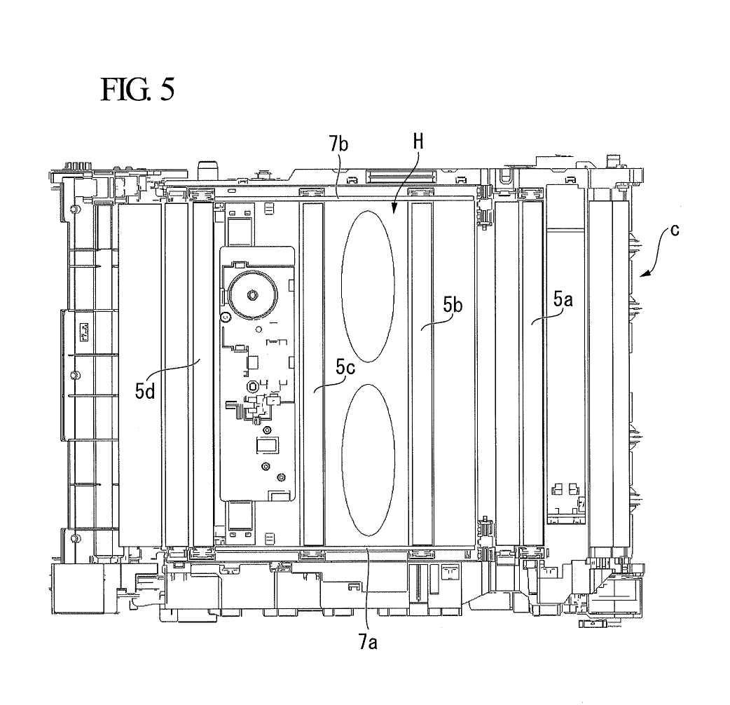

Hereinafter, the intermediate transfer belt c3 will be described using FIG. 2 through FIG. 5. FIGS. 2A and 2B show a portion of the developing unit c2, the intermediate transfer belt unit c3, the cleaning unit c4, and a portion of the secondary transfer unit c5 that have been extracted from the image forming section c shown in FIG. 1. FIG. 3 is a side view showing the intermediate transfer belt unit c3, the cleaning unit c4, and the secondary transfer unit c5, while FIG. 4 is a plan view of the same, and FIG. 5 is a plan view thereof from which the intermediate transfer belt has been excluded. Note that FIG. 2A shows the position of a housing H during color printing, while FIG. 2B shows the position of the housing H during black monochrome printing (this is described in detail below).

The housing for color (referred to hereinafter simply as ‘housing’) H, as well as shielding components 7a and 7b are included in the intermediate transfer belt unit c3.

The housing H (i.e., a supporting portion) is provided in a position on the inside of the endless intermediate transfer belt 2 which is suspended between the drive roller 3 and the tension roller 4, and in a position that also corresponds to the three transfer rollers 5b-5d for yellow, magenta, and cyan which are used for color printing from among the primary transfer rollers 5a-5d. In addition, the housing H applies force to the transfer rollers 5b-5d so as to urge them towards the photosensitive drums 1b-1d, and also supports them such that they are able to rotate.

The housing H has side plates 8a and 8b that are located respectively on both sides of a direction that orthogonally intersects the direction of movement of the intermediate transfer belt 2 (see the arrows in FIG. 1). The primary transfer rollers 5a-5d are provided between the side plates 8a and 8b at predetermined distances from each other in the direction of movement of the intermediate transfer belt 2, and are each pivotally supported such that they are able to rotate freely via bushes which are made from an electrically conductive material. Coil springs are provided such that they impart urging force to these bushes between the side plates 8a and 8b.

Moreover, a supporting shaft 9 is provided at one end side in the direction of movement of the intermediate transfer belt 2 (i.e., the right end side in FIGS. 2A and 2B) in the housing H, and the housing H is pivotally supported such that it is able to rotate freely on the frame of the intermediate transfer belt unit c3. On the other end of the housing H, namely, on the opposite end thereof from the supporting shaft 9, there is provided a conversion roller 10a that is supported such that it is able to rotate while remaining in a fixed position relative to the housing H. In addition, an idling roller 10b is supported such it is able to rotate while remaining in a fixed position between the primary transfer roller 5a and the supporting shaft 9 of the housing H, and another idling roller 10b is also supported such it is able to rotate while remaining in a fixed position between the primary transfer roller 5a and the drive roller 3.

In color printing mode, the housing H is pivoted by a pivoting source (not shown) in the manner shown in FIG. 2A, and the three transfer rollers 5b to 5d can be pressed against the photosensitive drums 1b-d that are provided correspondingly to these rollers. At this time, the bottom ends of the circumferential surfaces of the conversion roller 10a and the idling rollers 10b are positioned substantially on a straight line that connects together the circumferential surfaces of the photosensitive drums 1a-1d. The primary transfer rollers 5a-5d are then impelled towards the axes of the corresponding photosensitive drums 1a-1d, and are placed in contact under pressure with the inner surface of the intermediate transfer belt 2.

### Second Embodiment

Furthermore, in black monochrome printing mode, the housing H is pivoted by the pivoting source in the manner shown in FIG. 2B, and the three transfer rollers 5b to 5d together with the idling rollers 10b can be moved away (i.e., pulled back) from the photosensitive drums 1b-1d that are provided correspondingly thereto. At this time, the slack in the intermediate transfer belt 2 is absorbed by the tension roller 4, however, because the intermediate transfer belt 2 is moved slightly outwards between the conversion roller 10a and the idling rollers 10b as a result of it being pressed against by the primary transfer rollers 5b-5d and the like, the gap between the inner surface of the intermediate transfer belt 2 and the housing H facing it becomes larger.

The shielding components 7a and 7b are placed between the housing H and the intermediate transfer belt 2, and are provided respectively on both sides of a direction that orthogonally intersects the direction of movement of the intermediate transfer belt 2.

The shielding components 7a and 7b are fixed to the housing H such that they are able to seal off the gap between the intermediate transfer belt 2 and the housing H on both lateral sides of the direction of movement of the intermediate transfer belt 2, and are in sliding contact with the inner surface of the intermediate transfer belt 2.

### Third Embodiment

These shielding components 7a and 7b are formed from an electrically non-conductive material (i.e., are electrical insulators), and are able to prevent leakage from between the primary transfer rollers 5a-5d.

### Fourth Embodiment

As the shielding components that are formed from an electrically non-conductive material (electrical insulating material), any form of brush, felt, or film may be used provided that it is able to seal off the gaps during the above-described color printing mode and monochrome printing mode. Examples of this shielding component that is formed from an electrically non-conductive material include an acrylic pile seal (pile material: No. 52 two-ply thread, pile density: 880 bundles/sq. inch) manufactured by Toei Sangyo Co., Ltd. and the like.

The shielding components 7a and 7b are formed by cutting this sheet component to a width of approximately 4 mm, and then adhering the cut pieces to a flat portion of the housing H using an adhesive component such as two-sided tape. Because acrylic pile seal is capable of contracting and expanding slightly in a thickness direction via deformation of the pile, it is possible to seal off the gaps in both the color printing mode and the monochrome printing mode.

In the printer P that is provided with shielding components 7a and 7b having the above-described structure, the ingress of toner through the gaps between the housing H and the intermediate transfer belt 2 is greatly reduced. Accordingly, there is a large reduction in the amount of toner that adheres to the inner surface of the intermediate transfer belt, and then becomes attached to the rollers which support the intermediate transfer belt 2 so as to obstruct the smoothness of the surface of the rollers. Consequently, the cleaning of the outer surface side of the intermediate transfer belt can be performed excellently. As a result, decreases in the print quality that are the result of cleaning defects can be effectively prevented.

While preferred embodiments of the invention have been described and illustrated above with reference made to the attached drawings, it should be understood that the present disclosure is not limited to the above-described embodiments. The various configurations and combinations and the like of the respective component elements illustrated in the foregoing embodiments are exemplary of the invention and additions, omissions, substitutions, and other modifications can be made based on the design requirements without departing from the spirit or scope of the present disclosure.

Moreover, in the above-described examples, the intermediate transfer belt unit c3 is positioned above the photosensitive drums 1a-1d, however, the printer may also be configured such that the intermediate transfer belt unit c3 is positioned below the photosensitive drums 1a-1d.

Furthermore, in the foregoing description, a printer is used as an example of an image forming apparatus; however, the image forming apparatus may also be a copy machine, a facsimile machine, or a multi-function printer which is provided with these functions.

Moreover, in these embodiments, an information processing device C converts information data into PDL format data, and a multi-function printer A converts the PDL format data into bitmap image data; however, it is also possible for the information processing device C to be incorporated in the multi-function printer A, and for the multi-function printer A to acquire information data from a delivery server D, and to then convert this information data into bitmap image data and then store this bitmap image data, and, upon receiving an output command, information processing device C forms an image based on the converted bitmap image data.

Moreover, it is also possible for the multi-function printer A to acquire information data from the delivery server D, and to convert this information data into PDL format data, and to then store this PDL format data without converting it. When the multi-function printer A then receives an output command, it can then convert the PDL format data into bitmap image data. Alternatively, when the image processing device C acquires information data from the delivery server D, it is also possible for it to then convert this information data into bitmap image data, and to then output this converted bitmap image data to the multi-function printer A.

Furthermore, in the multi-function printer A, prior to the PDL format data being converted into bitmap image data, it is also possible for a main control section 8 to calculate the volume of the bitmap image data that would be obtained after it was converted, and if the volume of the bitmap image data would exceed a predetermined volume, the main control section 8 does not convert the PDL format data and stores the unconverted PDL format data in a first data storage section 3, and then, upon receiving an output command by a display section 1, the main control section 8 converts the PDL format data into bitmap image data. Because the volume of bitmap image data is larger than the volume of PDL format data, the above-described operations make it possible to prevent the storage section coming under excessive pressure.

In the above described embodiments, information data is acquired from the delivery server D, however, the present disclosure is not limited to this. For example, it is also possible for information data to be acquired from an external storage medium such as USB memory or the like.

According to the present disclosure, because shielding components are provided between a transfer roller supporting portion and an intermediate transfer belt on both sides of a direction that orthogonally intersects the direction of movement of that intermediate transfer belt, it is possible to effectively prevent toner falling onto the inner surface side of the intermediate transfer belt. Accordingly, because toner can no longer enter via the gap between the transfer roller supporting section and the intermediate transfer belt and adhere to the inner surface of the intermediate transfer belt, the inner surface side of the intermediate transfer belt can be completely cleaned, and any deterioration in print quality can thereby be prevented.

What is claimed is:

1. An image forming apparatus comprising:
photosensitive drums:
an intermediate transfer belt onto which toner images are transferred from the photosensitive drums;
transfer rollers configured to face the photosensitive drums and nip the intermediate transfer belt between themselves and the photosensitive drums;
supporting portions located on both sides of a direction that orthogonally intersects a direction of movement of the intermediate transfer belt, and configured to pivotally support the transfer rollers; and
shielding components located between the supporting portions and a inner surface of the intermediate transfer belt, and fixed to the supporting portions.

2. The image forming apparatus according to claim 1, wherein the image forming apparatus has a color mode and a monochrome mode,
remaining transfer rollers of the transfer rollers are not used in the monochrome mode, the remaining transfer rollers are supported and urged by the supporting portions towards the photosensitive drums, and
in the monochrome mode, as a result of movement of the supporting portions, the remaining transfer rollers are withdrawn together with the intermediate transfer belt from the surface of the photosensitive drums.

3. The image forming apparatus according to claim 1, wherein the shielding components are formed by electrical insulating material.

4. The image forming apparatus according to claim 1, wherein the shielding components are formed from brush, felt, or film, and are in sliding contact with the intermediate transfer belt.
